(19) United States
(12) Patent Application Publication
(10) Pub. No.: US 2006/0236520 A1
(43) Pub. Date: Oct. 26, 2006

(54) Method for manufacturing headrest stay

(75) Inventor: Tokuji Arai, Aisai-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: ARAI INDUSTRIAL CO., LTD., Aisai-shi (JP); INOAC CORPORATION, Nagoya-shi (JP)

(21) Appl. No.: 11/410,199

(22) Filed: Apr. 25, 2006

(30) Foreign Application Priority Data
Apr. 26, 2005 (JP) 2005-128402

(51) Int. Cl. B23P 25/00; B21B 1/46; B21D 47/00

(52) U.S. Cl. 29/458; 29/527.2; 29/897.3

(57) ABSTRACT

The manufacturing method of the present invention is a method for manufacturing a headrest stay including an embedded portion to be embedded into a headrest main body, and inserted portions to be inserted into a top portion of a seat back integrally made of a metal pipe into one piece unit. This manufacturing method includes the steps of: cutting a linear-shaped metal pipe material into a predetermined length; chamfering end surfaces of the cut metal pipe; forming a notch at a predetermined position on an outer peripheral surface of the metal pipe; plating the surface of the linear-shaped metal pipe so as to form a plated layer after the chamfering and notch forming steps; and bending the plated metal pipe into the shape of the substantially letter U, wherein said bending step is executed after said plating step.

### FIELD OF THE INVENTION

The present invention relates to a method for manufacturing a headrest stay which is used as a supporting member of a headrest to be mounted on a top portion of a seat back of a vehicle seat.

### DESCRIPTION OF THE RELATED ART

Normally, a headrest is mounted on a top portion of seat back of a vehicle seat. The headrest generally includes a headrest main body including a pad molded from a foaming material and the like, and a headrest stay substantially in the shape of letter U which is embedded within the headrest main body and has opposite end portions protruding form the headrest main body (for example, see Japanese Patent Laid-Open Publication No. 2004-14959).

Such a headrest stay to be used in the headrest is generally made of a metal pipe bent into the shape of substantially letter U. The metal pipe is chamfered at its end surfaces, and at the same time, is notched at its predetermined position, and further, is plated on its outer peripheral surface for the purpose of rust prevention and decoration.

The headrest stays, each manufactured by being bent into a predetermined shape and then subjected to plating, are transported to a manufacturing plant for a headrest main body where the headrest main body including a pad is formed to be mounted on its upper portion.

By the way, the headrest stay is made of a metal pipe as a material which is to be bent and plated. On the other hand, the headrest main body including a pad is manufactured by forming a top surface layer including cloth material and the like onto the surface of a pad made of a foaming material such as polyurethane foam. Therefore, the headrest stay and the headrest main body are normally manufactured in separate plants or separate manufacturers from each other.

As described above, since the headrest stay is generally manufactured by the separate plant or separate manufacturer from the headrest main body manufacturer, after being manufactured in a metal processing plant, the headrest stay will be transported to another headrest manufacturing plant such as a synthetic resin product processing plant. Further, in recent years, there are many cases where headrest manufacturing plants are located in various places including overseas. As a result, there are increasing cases where the metal processing plant for manufacturing headrest stays and the headrest manufacturing plant are distanced far away from each other, and are located far from each other.

In view of the above problem, it is conceived that a manufacturing line for manufacturing a headrest stay is prepared within the premise of a headrest manufacturing plant, or a metal processing plant for headrest stay is established in the vicinity of a headrest manufacturing plant so as to manufacture headrest stays. In this case, however, there arises a problem that many pieces of equipment such as a cutting machine, plating processing equipment, and a bending machine, and high-level processing techniques are required, and therefore high equipment investment cost is required.

In this circumstance, it is the best method which is practically feasible at the lowest equipment investment cost to transport headrest stays manufactured in the existing metal processing plant to a distanced headrest manufacturing plant. However, since a headrest stay is a three dimensional solid state formed by bending a metal pipe into the shape of substantially letter U, if headrest stays are packed in a simple package or are bound together simply, the piles of the headrest stays tend to collapse during the transportation and are damaged. Therefore, the packaging and transportation of the headrest stays are difficult beyond expectations. For their transportation, dedicated containers (boxes for transportations) are prepared, and headrest stays are housed therein in a state where they are placed adjacent to each other in a good order and are transported to a headrest manufacturing plant.

However, in the case where headrest stays are transported using the dedicated containers, much labor work is required for transporting the dedicated containers from the metal processing plant to the headrest manufacturing plant and then returning them from the headrest manufacturing plant to the meal processing plant. In addition, since each of the headrest stays housed in a container has a complicated, three dimensionally bent solid shape, they are transported with some space left from each other. As a result, there arise problems that the transportation efficiency is poor and the transportation cost becomes very high.

In addition, for the headrest manufacturing plant, much cost is required for transporting the headrest stays. However, if the headrest manufacturing plant purchases a very large quantity of headrest stays at one time in order to avoid frequent transportations, a stock of headrest stays increases. The increase in the stock is also likely to result in the increased manufacturing cost.

### SUMMARY OF THE INVENTION

An objective of the present invention is to provide a method for manufacturing a headrest stay capable of dramatically reducing manufacturing cost by reducing the transportation cost etc.

The objective of the present invention can be achieved by the method for manufacturing a headrest stay in the following structure.

Specifically, in a method for manufacturing a headrest stay according to the present invention, the headrest stay is made of a metal pipe and integrally formed of an embedded portion to be embedded into a headrest main body, and inserted portions to be inserted into a top portion of a seat back, comprising the steps of: cutting a linear-shaped metal pipe material into a predetermined length; chamfering end surfaces of the cut metal pipe; forming a notch at a predetermined position on an outer peripheral surface of the metal pipe; plating the surface of the linear-shaped metal pipe so as to form a plated layer after the chamfering and notch forming steps; and bending the plated metal pipe into the shape of the substantially letter U so as to form said inserted portions at opposite end portions whereas forming said embedded portion at a middle portion after the plating step, wherein said bending step is executed after said plating step.

Here, in said plating step, the thickness of the plated layer at the middle portion of the linear-shaped metal pipe which will be the embedded portion of said headrest stay is made to be smaller than the plated layer of the vicinity of the opposite end portions of the metal pipe which will be the inserted portions of said headrest stay.

Further, in said plating step, plating is executed by electroplating; the linear-shaped metal pipes are held to arrange by a plating tool; the each metal pipe is pinched at its one end portion and the other end portion respectively by one clamp and the other clamp connected to cathode electrodes; a plurality of thus-held metal pipes are arranged adjacent to each other and soaked into a plating bath; and the plating is executed in a state where a non-conductive shielding plate is attached to said plating tool to enclose the vicinity of the middle portion of said metal pipe.

In the manufacturing method described above, the linear-shaped metal pipe is plated to form a plated layer on the surface thereof. Therefore, the metal pipe formed with a plated layer such as a nickel-chrome plated layer for example on its surface has excellent decoration property, corrosion resistance, and abrasion resistance. No rust occurs on the surface. In addition, since the metal pipe is in a linear shape and hard to be scratched, a plurality of metal pipes can be transported in a simple binding and packaging. Therefore, in the case where a headrest stay manufacturing plant and a headrest manufacturing plant are distanced away from each other, the plated linear-shaped metal pipes can be transported in the following manner at very low transportation cost.

Specifically, since the linear-shaped metal pipes are transported, there is no need of dedicated containers for transporting conventional three-dimensionally bent headrest stays. A plurality of metal pipes is easily bound together and packed into corrugated boxes and the like, and can be transported in this state. Therefore, the transportation cost can be dramatically reduced as compared with the cost of transporting conventional three-dimensionally bent headrest stays.

In addition, the metal pipes can be bent into a predetermined shape after the transportation by a bender installed within a headrest manufacturing plant or within a plant in the vicinity of the headrest manufacturing plant. The bending of the metal pipes by the bender does not involve any process such as a preliminary process and a subsequent process unlike the cutting and plating processes, and is far simple.

Therefore, by installing a dedicated bender at one site within a headrest manufacturing plant, or by establishing a simple plant equipped with a bender at a location adjacent to the headrest manufacturing plant, a required quantity of the headrest stays can be immediately bent in the headrest manufacturing plant, and the resultant headrest stays can be supplied to the manufacturing line of the same plant.

Further, in the plating step, by forming the linear-shaped metal pipe into a structure in which the thickness of the plated layer at the middle portion of the metal pipe which will be an embedded portion of the headrest stay is smaller than the plated layer of the vicinity of the opposite end portions of the metal pipe which will be inserted portions of the headrest stay, no cracks occur on the plated layers when the middle portion of the metal pipe is bent to create the embedded portions of the headrest main body, and the bending can be executed successfully.

Further, since a plated layer of a sufficient thickness can be formed in the vicinity of the opposite end portions of the metal pipe which will be the inserted portions of the headrest stay, even if the opposite end portions of the stay are in an exposed state when the stay is used for the headrest, the plated layer has excellent decoration property, corrosion resistance and abrasion resistance. As a result, the headrest stay works excellently.

Further, the middle portion of the metal pipe formed with a thin plated layer is a portion which is bent to form an embedded portion to be embedded into the headrest main body. Therefore, no trouble due to the thinness of the plated layer at the middle portion of the stay arises at all after the headrest is manufactured and applied in actual use. Rather, by reducing the thickness of the plated layer of the portion which will be hidden inside the headrest main body and therefore does not require the plated layer so much, the use amount of the metal plating material such as nickel and chromium is saved, thereby reducing the manufacturing cost.

### BRIEF DESCRIPTION OF THE DRAWINGS

FIG. 1 is a diagram for illustrating the steps of the method for manufacturing a headrest stay according to an embodiment of the present invention.

FIG. 2 is a diagram for illustrating the step of bending process in the manufacturing method.

FIG. 3 is a front view of a plating tool.

FIG. 4A is a front view of a manufactured headrest stay, and FIG. 4B is a side view thereof.

FIG. 5A is a front view of a headrest stay of another example, and FIG. 5B is a side view thereof.

### DESCRIPTION OF THE PREFERRED EMBODIMENTS

Hereinafter, the present invention will be described based on the embodiments shown in the drawings. It should be noted that the present invention is not limited to the embodiments, and various modifications within the matters of the claims and equivalents related to the matters of the claims are included in the scope of claims.

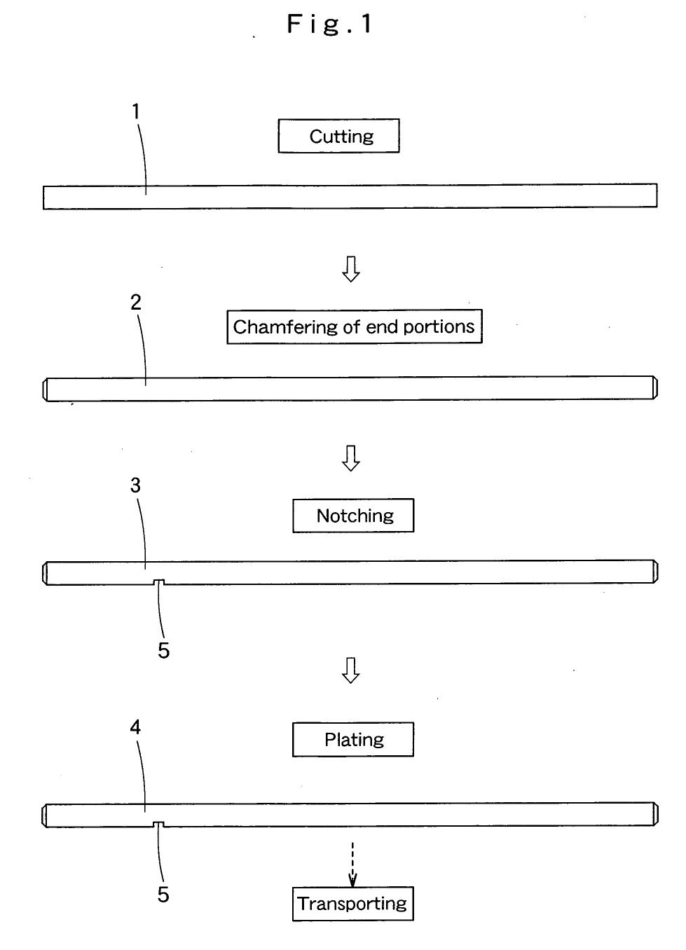

FIG. 1 shows a process diagram of a method for manufacturing a headrest stay. The headrest stay manufactured here is generally formed in the following steps. That is, a linear-shaped metal pipe is cut into a predetermined length, and the resultant linear-shaped metal pipe is plated on its surface, and after that, the plated metal pipe is bent into a predetermined shape substantially in the letter U.

As shown in FIG. 1, first of all, a metal pipe material is cut into a predetermined length to form a metal pipe 1. As the metal pipe material, for example, a high tensile steel pipe having a thickness of about 1.5 to 2.0 mm and an outer diameter of about 12 mm is used. This is a pipe material which exhibits high rigidity enough to maintain the position of the headrest when a predetermined load is applied to the headrest during when the headrest is used.

The cut metal pipe 1 has opposite end surfaces (cut surfaces) cut at sharp angles or formed with burr. Therefore, the metal pipe 1 is processed by a chamfering machine to chamfer the corner portions of the opposite end surfaces at a bevel.

Further, at a predetermined position on the outer peripheral portion of the chamfered metal pipe 2, a notch 5 is created as a groove-shaped recess portion. The notch 5 is formed to be an engaging portion on one side of an inserted portion 21 of a headrest stay 15 when the metal pipe 3 is finally formed into a headrest stay 15. The notch 5 is created at a predetermined position on the outer periphery of the pipe by cutting or pressing. In other words, when a headrest including the headrest stay 15 is fixed to a holder mounted on the top portion of the seat back of a vehicle seat with the inserted portion 21 of the headrest stay 15 inserted and engaged with the holder, the notch 5 constitutes an engaging portion to be engaged with an engaging member of a holder.

The linear-shaped metal pipe 3, after being chamfered at the opposite end surfaces and formed with the notch 5, is then plated by electroplating. The plating is nickel-chrome plating. The thickness of the plated metal pipe 4 resulted from the plating is differentiated between the vicinity of the opposite end portions and the middle portion of the linear-shaped metal pipe 4. That is, the metal pipe 4 is plated in such a manner that the plated layer at the middle portion thereof is formed into smaller thickness than the plated layer formed in the vicinity of the opposite end portions thereof.

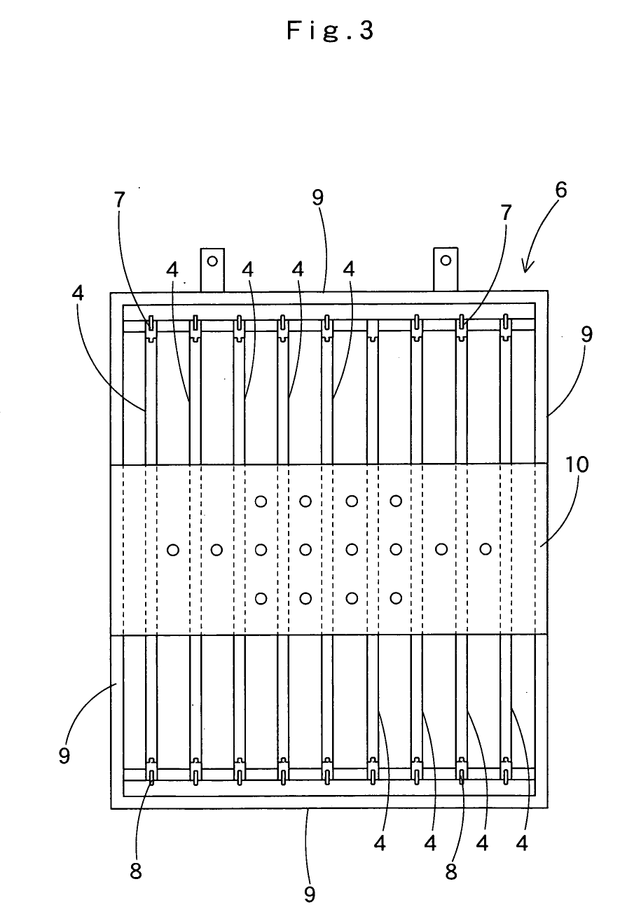

FIG. 3 shows a plating tool 6 for use in the plating process. The plating tool 6 is a tool for supporting linear-shaped metal pipes 3 which are substances to be plated in a state where they are arranged adjacent to each other in a longitudinal direction. As shown in FIG. 3, the plating tool 6 includes upper clamps 7 at predetermined intervals on the upper portion of a rectangular tool frame 9, and lower clamps 8 at the same intervals as the upper clamps 7 on the lower portion of the tool frame 9, in such a manner that a large quantity of linear-shaped metal pipes 3 can be held in a state where they are arranged adjacent to each other in a longitudinal direction. Each metal pipe 3 which is a substance to be plated is held at its upper end and lower end by the upper clamp 7 and the lower clamp 8, so that the metal pipes 3 are supported in a state where they are arranged adjacent to each other along a horizontal direction in an upright posture.

Further, the plating tool 6 includes, at its middle portion, a non-conductive (for example, made of synthetic resin) shielding plate 10 attached to the tool frame 9 in such a manner that the shielding plate 10 encloses the middle portions of the metal pipes 3 excluding their opposite end portions. This shielding plate 10 is attached in order that the nickel ion as plating metal reaches the middle portion of each metal pipe 3 at a reduced rate and that the thickness of the plated layer formed on the middle portion of each metal pipe 3 becomes smaller than the thickness of the plated layer formed in the vicinity of the opposite end portions of the metal pipe 3. The shielding plate 10 is formed with the proper number of through holes with proper size. In addition, spaces are provided above, below, and inside the shielding plate 10 within a plating bath, so that some nickel ion reaches the middle portion of each metal pipe 3 and a thin plated layer is formed around the middle portion.

Each upper clamp 7 and each lower clamp 8 of the plating tool 6 together constitute a cathode electrode for electroplating, and are connected to cathode terminals of power supply for electroplating. As a result, the opposite end portions of each metal pipe 3 are connected with cathode electrodes for electroplating. The upper portion of the tool frame 9 of the plating tool 6 is suspended to a non-illustrated suspending device, and is supported so as to be movable among plural plating baths. On the other hand, nickel metal material as a plating anode material is accommodated within a plating bath into which the metal pipes 3 held by the plating tool 6 is soaked, and an anode electrode is connected thereto. The anode electrode is connected to the anode terminal of the power supply for plating.

The plating is nickel-chrome plating. Nickel plating is provided as an underlying plated layer, and chrome plating is provided after the nickel plating. For this reason, a chrome plating bath is installed next to a nickel plating bath. A chromic acid solution is accommodated in the chrome plating bath, and an insoluble anode (for example, a lead electrode coated with diamond) is provided within the plating bath. Then, an anode terminal of a power supply for electroplating is connected to the insoluble anode.

The plating tool 6 described above holds the metal pipes 3 by its upper clamp 7 and the lower clamp 8 in a state where the metal pipes 3 are arranged adjacent to each other in a longitudinal direction. Alternatively, the plating tool 6 may be structured so that it holds the metal pipes 3 at their opposite ends in a state where the metal pipes 3 are arranged adjacent to each other in a horizontal direction.

The nickel-chrome electroplating is conducted in the following steps. First of all, a large quantity of linear-shaped metal pipes 3 are arranged in a longitudinal direction in the plating tool 6 as described above in a state where they are arranged adjacent to each other at predetermined intervals. Each metal pipe 3 is held in a state where its upper portion and lower portion are pinched by the upper clamp 7 and the lower clamp 8. The surface of the metal pipe 3 as a substance to be plated is undercoated as necessary. The plating tool 6 holding the metal pipes 3 is put into a washing bath, where the surface of each metal pipe 3 is washed so as to be degreased.

Next, the plating tool 6 holding the metal pipes 3 is soaked into a nickel plating bath. Then, a direct current voltage for plating is applied between the anode electrodes of the upper and lower clamps 7 and 8 of the plating tool 6 and the anode electrode within the plating bath, and plating is conducted for a predetermined period of time in a state where the plating tool 6 is stayed still within the plating bath.

During the plating, nickel ions elute from the nickel material of the anode electrode. The eluted nickel ions move toward each metal pipe 3 as a substrate to be plated which is connected to a cathode electrode. On the surface of the metal pipe 3, nickel metal precipitates to form a nickel plated layer on the surface of the metal pipe 3. Normally, in the plating step, the higher current density of electrolytic solution as a plating solution within the plating bath is and the higher the density of the nickel ion is, the larger the thickness of the precipitated plated layer (plated film) becomes. Contrarily, the lower the current density of the plating solution is and the lower the density of the nickel ion is, the smaller the thickness of the precipitated plated layer (plated film) becomes.

In the plating process of this embodiment, as described above, since the cathode electrodes are connected to the opposite ends of each metal pipe 3 as a substance to be plated, the current density of the electrolytic solution around the opposite end portions of the metal pipe 3 located at a position close to the cathode electrode is higher than that at the middle portion of the pipe. In addition, the shielding plate 10 attached to the middle portion of the plating tool 6 makes it difficult for the nickel ions eluted in the plating solution to reach the area in the vicinity of the middle portion of each metal pipe 3.

As described above, nickel ions elute from the nickel material of the anode electrode, and the eluted nickel ions move toward each metal pipe 3 as a substance to be plated which is connected to the cathode electrode. On the surface of each metal pipe 3, nickel metal precipitates to form a nickel plated layer on the surface. The nickel ions eluted into the plating solution are hard to reach the area in the vicinity of the middle portion of the metal pipe 3. For this reason, after the plating for a predetermined period of time, on the surface of the metal pipe 4, a plated layer is formed at the middle portion into a thickness smaller than the thickness of the plated layer in the vicinity of the opposite end portions thereof. For example, the thickness of the nickel plated layer at the opposite end portions (to be inserted portions 21 of the headrest stay 15) of the plated metal pipe 4 is 8 to 12 μm, and preferably 9 to 11 μm. The thickness of the nickel plated layer of the middle portion (to be a embedded portion 16 of the headrest stay 15) of the metal pipe 4 is 2 to 5 μm, and preferably 3 to 4 μm.

As described above, the nickel plated layer of the opposite end portions of the plated metal pipe 4 to be inserted portions 21 of the headrest stay 15 is formed into a thickness (8 to 12 μm) larger than the thickness (2 to 5 μm) of the plated layer at the middle portion of the metal pipe 4 to be an embedded portion 16. Due to this structure, by providing chrome plating subsequent to the nickel plating, the metal pipe 4 gains excellent decoration property, corrosion resistance, and abrasion resistance.

The portion of the metal pipe 4 which will be the embedded portion 16 fitted into the headrest main body 20, that is, the middle portion of the metal pipe 4, is formed into a thickness (2 to 5 μm) that will not be rusted at least until it is embedded into the headrest main body 20 and that is sufficiently small but does not cause cracks during the bending process described later.

In addition, the nickel plating under the conditions such as described above can save the use amount of the nickel metal material as a nickel ion material by the amount corresponding to the reduced thickness of the plated layer at the middle portion, as compared with the conventional plating process in which nickel plated layer is formed into a uniform thickness on the surface of the headrest stay.

Next, chrome plating is provided onto the nickel plated layer to allow a chrome plated layer to precipitate onto the surface. The chrome plating is performed in the following manner. That is, the plating tool 6 holding the metal pipes 4 each formed with the nickel plated layer thereon as described above is transferred to the chrome plating bath as described above and is soaked therein, where the metal pipes 4 are chrome-plated. The chromium ions in the chromic acid solution (electrolytic solution) gather onto the surface of each metal pipe 4 (a metal pipe formed with a nickel plated layer on its surface) as a substance to be plated, and chromium metal precipitates on the surface. The chrome plated layer is formed onto the nickel plated layer into an extremely thin thickness (for example, into a thickness of about 0.1 μm).

The chromium metal plated layer forms a fine oxide film on the surface so as to prevent the nickel plating from discoloring, otherwise, the nickel plating would easily discolor. As a result, the metal pipe 4 formed with the nickel plated layer and the chrome plated layer thereon gains more excellent decoration property, corrosion resistance, and abrasion resistance. Further, the chrome plated layer described above is formed over the substantially entire surface of the metal pipe 4, and the thickness thereof is as very small as about 0.1 μm. Even during the bending process of the pipe, the chrome plated layer never causes the generation of cracks on the plated layer. Further, the chrome plated layer at the middle portion of the metal pipe 4 is formed into a thickness smaller than the thickness of the chrome plated layer at the opposite end portions thereof (for example, into the thickness of about 0.05 μm). As described above, the middle portion of the metal pipe 4 is to be an embedded portion 16 which will be embedded into the headrest main body 20. Therefore, no problem arises even if the thickness of the chrome plated layer is small, as far as the occurrence of rust can be prevented until the middle portion of the metal pipe 4 is embedded into the headrest main body 20 in the forming step of the headrest main body 20.

The linear-shaped plating metal pipes 4 after the nickel-chrome plating as described above are removed from the plating tool 6. After that, the metal pipes 4 as semi-products of the headrest stays 15 are transported to another locations, for example, to a headrest manufacturing plant in a remote region in the domestic country or overseas. When transported, the metal pipes 4 are enclosed in packages. Since the metal pipes 4 are in a linear shape, a proper number of pipes are bound together and packed into corrugated boxes for transportation. Thus, the metal pipes 4 can be transported in a simple package at low cost.

Conventional headrest stays have been transported in a state where they are bent into a three dimensional solid shape. Therefore, they are enclosed in dedicated containers when transported, and the volume of the space occupied by each stay increases when transported. Thus, much labor work is required for moving the containers between the plants, and a quantity of stays which can be transported by one transporting vehicle reduces. As a result, relatively high transporting cost is required. However, according to the method for manufacturing headrest stay of the present invention, the linear-shaped metal pipes 4 are bound together into a relatively compact state, and then are packed into corrugated boxes and the like instead of containers. In thus-packed state, the metal pipes are transported to a headrest manufacturing plant efficiently, and thus, the transporting cost can be reduced dramatically. Especially, transportation to not only to remote sites in the domestic country but also to overseas sites is enabled at relatively low transporting cost.

Then, the plated metal pipes 4 which have been plated as described above are transported to a headrest manufacturing plant or a bending plant adjacent to a headrest manufacturing plant. As a bending machine for a headrest stay, for example, it is possible to use a pipe bender including: a chuck portion formed with a mandrel shaft including a mandrel at its tip end; a rotatable bending roll located at one side portion of the bending mandrel shaft, the rotatable bending roll being formed with a circular arc-shaped recess for housing a metal pipe therein; a clamp die movable forward and backward with respect to the other side portion of the mandrel shaft and rotatably formed around the bending center as a shaft; and a pressure die for allowing the clamp die to move in the same direction.

As such a pipe bender, a relatively small-sized general-purpose pipe bender can be used. The pipe bender can easily be installed at one site within a headrest manufacturing plant, or a plant in the vicinity of the manufacturing plant. In a bending step, only a process of bending the metal pipes is conducted, and thus, no special technique is required. In addition, unlike plating, a process step involved with a preliminary process and a subsequent process is not required, and the metal pipes can be far easily processed.

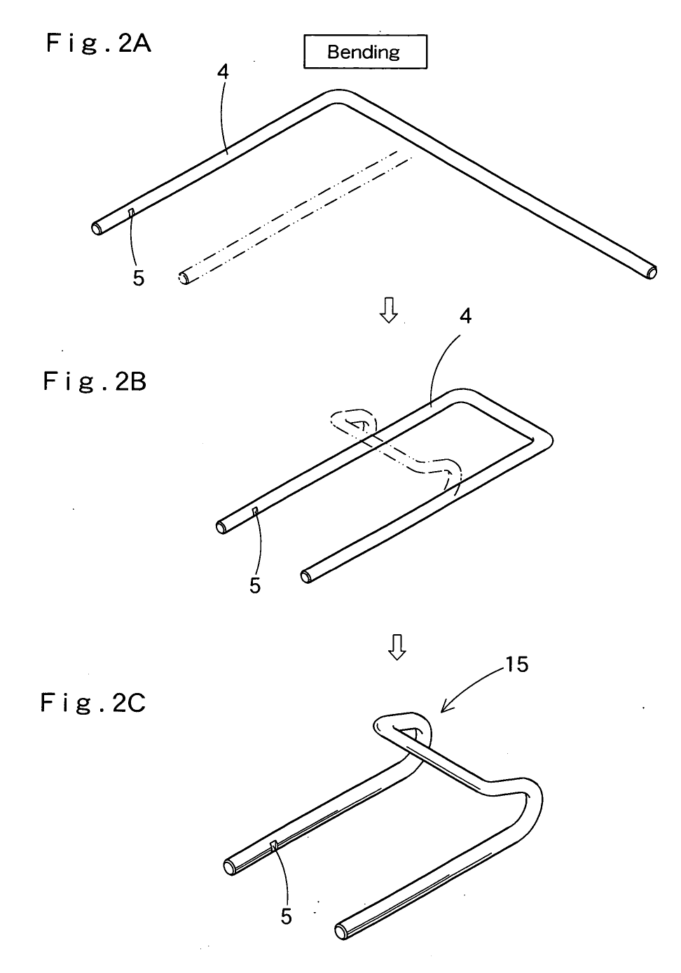

In a process of bending the metal pipe 4, as shown in FIG. 2, the bending is performed in the following three steps, for example. That is, first of all, as shown in FIG. 2A, on a flat plane, the metal pipe 4 is bent at its first corner portion at right angles, and its second corner portion at right angles as well. As a result, the metal pipe 4 assumes the shape of the substantially letter U. Next, as shown in FIG. 2B, the end portion of the metal pipe bent into the shape of the letter U is bent upward (three dimensionally) at a predetermined angle (for example at about 130 degrees). A portion of the metal pipe 4 bent in such a bending process is a middle portion excluding the opposite end portions and the vicinity thereof, and is formed with a plated layer smaller in thickness.

In the bending step by the bender such as described above, a stay plated with nickel chrome into a normal thickness as is the case of a conventional headrest stay tends to have cracks on the plated layer on the surface of the pipe when it is bent. Contrarily, the portion to be bent of the headrest stay 15 is a middle portion of the metal pipe 4 excluding its opposite end portions and the vicinity thereof, and is formed with a nickel plated layer having thickness as small as 2 to 5 μm. Therefore, the portion can be bent without the occurrence of cracks. In the bending process of the metal pipe 4 as described above, the embedded portion 16 of the headrest stay 15 is created, and the headrest stay 15 such as shown in FIG. 2C is completed.

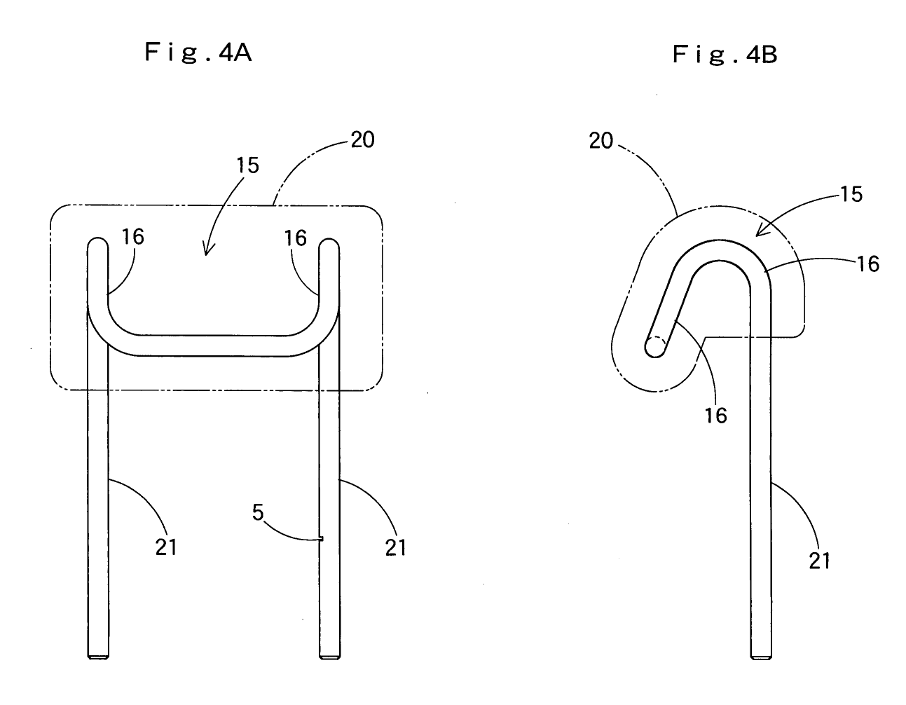

The headrest stay 15 manufactured in the above steps is supplied to a headrest manufacturing line. Then, as shown in FIG. 4, the headrest main body 20 is mounted to the bent upper portion of the headrest stay 15, that is, the embedded portion 16 in such a manner that the headrest main body 20 encloses the embedded portion 16 from outside. The headrest main body 20 includes a pad portion made of a foaming material such as polyurethane foam, and an outer surface made of a cloth material and the like formed to cover the surface of the pad portion. The portions protruding downward from the headrest main body 20 constitute inserted portions 21 of the stay. As a result, a headrest is completed.

The inserted portions 21 of the headrest stay protruding downward are formed so as to start from the vicinity of the opposite end portions excluding the middle portion of the metal pipe 4, as described above. The nickel plated layer and the chrome plated layer are both formed into required and sufficient thicknesses. Due to this structure, the inserted portions 21 have excellent decoration property, corrosion resistance, and abrasion resistance as described above. Thus, the headrest stay can be used with excellent durability when used in a state where the inserted portions 21 are inserted into the holder at the top portion of the seat back of the vehicle seat.

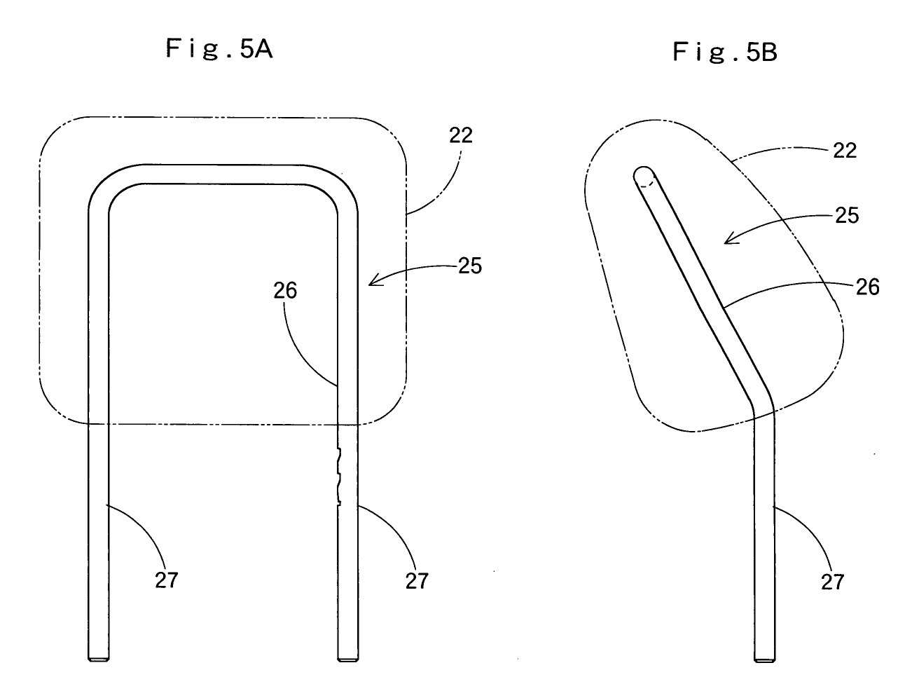

FIG. 5 shows a headrest stay 25 of another embodiment. In the headrest stay 15, an end portion of a metal pipe bent into the shape of letter U is bent upward by an angle smaller than the above (for example, at about 25 degrees). Due to this arrangement, the headrest stay 25 in the shape such as shown in FIG. 5 is completed. Then, as is the case of the above, a headrest main body 22 is mounted to the bent upper portion of the headrest stay 25, that is, the embedded portion 26 in such a manner that the headrest main body 22 covers the bent upper portion from outside. The headrest main body 22 is formed from the a pad portion made of a foaming material such as polyurethane foam, and a surface material made of a cloth material formed to cover the surface of the pad portion. Then, the portions protruding downward from the headrest main body 22 are inserted portions 27 of the stay, and the headrest is completed.

As described above, by installing a dedicated bender at one site within a headrest manufacturing plant or by establishing a simple plant equipped with a bender for a bending process at a location adjacent to a headrest manufacturing plant, the plated metal pipes 4 are easily bent to manufacture headrest stays 15 and 25 in a short time. Therefore, in the headrest manufacturing plant to which the metal pipes 4 are delivered, the headrest stays 15 and 25 of a required quantity can be immediately bent, and the resultant headrest stays 15 and 25 can be supplied to the manufacturing line of the same headrest manufacturing plant. As a result, the stock of the parts can be suppressed to the minimum, and the reduction in the manufacturing cost can be achieved.

By employing the method for manufacturing a headrest stay such as described above, headrest stays can be manufactured at the minimum equipment investment while using an existing metal processing plant, and the resultant headrest stays can be delivered to a headrest manufacturing plant at low transportation cost.

What is claimed is:

1. A method for manufacturing a headrest stay including an embedded portion to be embedded into a headrest main body, and inserted portions to be inserted into a top portion of a seat back integrally made of a metal pipe in one piece unit, comprising the steps of:
cutting a linear-shaped metal pipe material into a predetermined length;
chamfering end surfaces of the cut metal pipe;
forming a notch at a predetermined position on an outer peripheral surface of the metal pipe;
plating the surface of the linear-shaped metal pipe so as to form a plated layer after the chamfering and notch forming steps; and
bending the plated metal pipe into the shape of the substantially letter U so as to form said inserted portions at opposite end portions whereas forming said embedded portion at a middle portion after the plating step,
wherein said bending step is executed after said plating step.

2. A method for manufacturing a headrest stay according to claim 1, wherein in said plating step, the thickness of the plated layer at the middle portion of the linear-shaped metal pipe which will be the embedded portion of said headrest stay is made to be smaller than the plated layer of the vicinity of the opposite end portions of the metal pipe which will be the inserted portions of said headrest stay.

3. A method for manufacturing a headrest stay according to claim 2, wherein in said plating step, plating is executed by electroplating; the linear-shaped metal pipe is held by a plating tool; the metal pipe is pinched at its one end portion and the other end portion respectively by one clamp and the other clamp connected to cathode electrodes; and a plurality of thus-held metal pipes are arranged adjacent to each other and soaked into a plating bath; and the plating is executed in a state where a non-conductive shielding plate is attached to said plating tool to enclose the vicinity of the middle portion of said metal pipe.
